(19) United States
(12) Patent Application Publication
(10) Pub. No.: US 2014/0096709 A1
(43) Pub. Date: Apr. 10, 2014

(54) MOBILE VALIDATING SYSTEM

(71) Applicant: FKI SECURITY PRODUCTS, New Albany, IN (US)

(72) Inventors: Edward McGunn, Chicago, IL (US); David Murch, Chicago, IL (US); Daniel Jones, Elizabeth, IN (US); Terry Densmore, Sellersburg, IN (US); Michael J. Smith, Scottsburg, IN (US)

(73) Assignee: FKI SECURITY PRODUCTS, New Albany, IN (US)

(21) Appl. No.: 13/648,503

(22) Filed: Oct. 10, 2012

(51) Int. Cl. E05G 1/02; G07D 7/00

(52) U.S. Cl. 109/52

(57) ABSTRACT

A validating system is contemplated to facilitate interchangeable use of safes configured to electronically validate paper currency or other types of currency. The validating system may allow currency delivery entities to exchange safes rather than having to remove a cassette or otherwise access contents stored within the safe.

### TECHNICAL FIELD

The present invention relates to validating systems, such as but not necessarily limited to mobile validating systems having capabilities sufficient to facilitate exchange of safes configured to validate paper or other types of currency.

### BACKGROUND

A validating system may be configured to validate, count, or otherwise process paper currency or other forms of currency, typically by scanning or otherwise electronically processing the currency. U.S. patent application Ser. No. 10/903,119, the disclosure of which is hereby incorporated by reference in its entirety, relates to one type of validating system. U.S. Pat. No. 7,063,252, the disclosure of which is hereby incorporated by reference in its entirety, relates to a centralized electronic safe and accounting control system, which may be suitable for use in facilitating control and processing of safes and/or other devices associated with a validating system.

### BRIEF DESCRIPTION OF THE DRAWINGS

FIG. 1 illustrates a validating system as contemplated by one non-limiting aspect of the present invention.

FIG. 2 illustrates removal of a safe from a sleeve in accordance with one non-limiting aspect of the present invention

FIG. 3 illustrates a rear view validating system as contemplated by one non-limiting aspect of the present invention.

FIG. 4 illustrates an electronic touchscreen as contemplated by one non-limiting aspect of the present invention.

FIG. 5 illustrates a flowchart of a method of facilitating safe exchange in accordance with one non-limiting aspect of the present invention

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

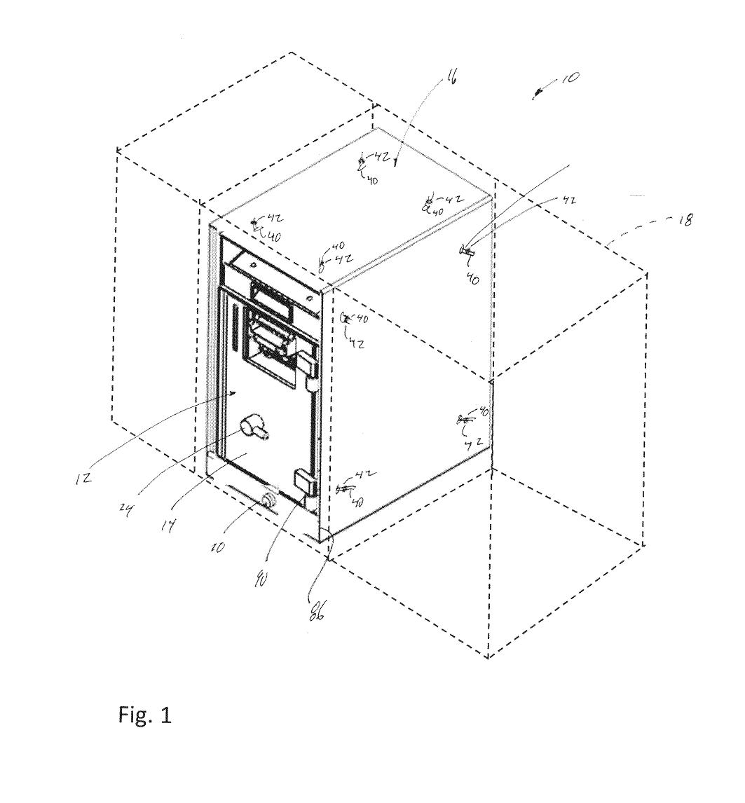

FIG. 1 illustrates a validating system 10 as contemplated by one non-limiting aspect of the present invention. The validating system 10 may be configured to facilitate processing currency, such as paper currency, e.g., bills, receipts, checks, etc., and/or coin currency. The validating system may include a safe 12 configured to process currency for safekeeping within a storage cassette (not shown) accessible through a lockable door 14. The safe 12 may be configured in accordance with U.S. patent application Ser. No. 10/903,119 and controlled according to U.S. Pat. No. 7,063,252, the disclosures of which are hereby incorporated by reference in their entirety. The safe may be removably secured within a sleeve 16 affixed to a cabinet or other structure 18. The cabinet 18 is shown in phantom to better highlight the positioning of the safe 12 and the sleeve 16. While the cabinet 18 is shown, any suitably permanent, stationary, rigid or fixed structure may be used if it is immovable or otherwise sufficiently immovable to provide desired levels of security may be affixed to the sleeve, i.e., any structure that is not easily carried away may be used. The sleeve 16 may include a lock 20 configured to lock the safe 12 within the sleeve 16, which when coupled with the sleeve 16 being attached to the cabinet 18, essentially prevents the safe 12 from being transportable.

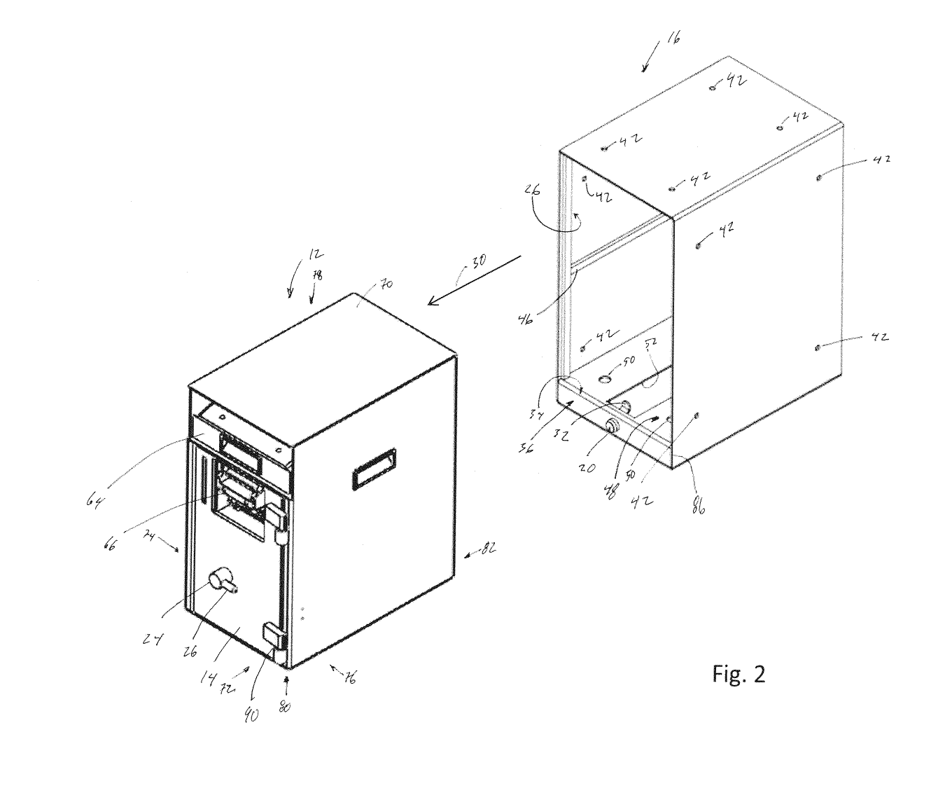

The lock 20 may be actuated will between a locked and an unlocked position such that the safe 12 can be easily removed when actuated to the unlocked positioned and easily secured when actuated to the locked position. FIG. 2 illustrates removal of the safe 12 from the sleeve 16 in accordance with one non-limiting aspect of the present invention. The safe 12 may be removed from the sleeve 16 in order to facilitate exchange with a new safe 12. One non-limiting aspect of the present invention contemplates a safe exchange process where a security provider would replace an existing safe 12 with a new safe 12 when retrieving the contents of the safe. The new safe may be a mirror image of the replaced safe in order to allow it to be easy replaced within the sleeve 16. Once the new safe 12 is properly position within the sleeve 16, the lock 20 may be actuated back to the locked position in order to secure the new safe 12. The present invention also contemplates the service provider retrieving the contents stored in the safe 12 by opening the lockable safe door 14 and retrieving the storage cassette. In some cases it may be beneficial for the service provider to retrieve the storage cassette instead of the entire safe 12, e.g., when space is limited or the combined weight of the safe and contents is excessive. The exchange of the safe 12 is believed to be more preferable than retrieving the storage cassette since the contents of the safe 12 are not exposed during the exchange.

The exchange program allows the safe contents to remain secured within the safe 12 at all times during transport. One would need to crack the safe 12 or otherwise actuate a lock 24 on the lockable door in order to gain access to the safe contents. This capability allows the present invention to maintain security over the safe contents during transportation to another location for further processing, or at least an enhanced level security beyond that provided by the storage cassette. The safe 12 may be removed from the sleeve 16 through an opening 26 of an approximately equal dimensional configuration. The safe removal process may occur by pulling on the lock 24, a door handle 26 of the lockable door 14 or through some other means, which may be dependent on a weight, size or configuration of the particular safe 12 and/or the sleeve 16. FIG. 2 generally illustrates the safe 12 being laterally removable in a forward direction 30 once an arm 32 associated with the sleeve lock 20 is positioned below an upper portion 34 of a wall 36 included on a forward portion of the sleeve 16. This exemplary configuration and removal process is not intended to necessarily limit the scope and contemplation of the present invention as the present invention fully contemplates other shapes and configurations for the safe 12 and/or the sleeve 16 and other processes for sliding, replacing or otherwise facilitating exchange of the old safe 12 for a new safe 12.

A plurality of fasteners 40 may be configured to secure the sleeve 16 to the cabinet 18 or an associated support structure, such as but not limited to a cement floor supporting the cabinet 18. The fasteners 40 are shown to be screws configured to be anchored to the cabinet 18, optionally with assistance from an adhesive or other element. The sleeve 16 may include a plurality of apertures 42 configured to receive the fasteners 40 for connection to the cabinet 18. The apertures 42 may be sized and shaped relative to a head of the fasteners 40 such that a portion of the fasteners extend beyond the aperture 42 to compress the sleeve 16 against the cabinet 18 in a secure manner. The fasteners 40 may be screwed into place or otherwise embedded within the cabinet 18 using a tool, such as but not necessarily limited to a screwdriver. The tool used to secure the fasteners 40 may be unsecured in comparison with a key, combination, code, etc. used to secure the lockable door 14 of the safe 12, at least in so far as the implement used to remove the fasteners 40 may be generally available whereas the implement to access the storage cassette may be not so generally available. The safe 12 may be sufficiently sized and shaped and configured to operate in cooperation with the size and shape of the sleeve 16, including the positioning of the apertures 42, to prevent access to the fasteners 40 while the safe 12 is seated within the sleeve 16. The hidden position of at least some of the fasteners 40 or other similar retaining element may be beneficial in essentially preventing their removal while the safe 12 is properly seated.

The sleeve 16 may include one or more bumpers 46 or other types of offsets to prevent contact between the fasteners 40 and the safe 12 during insert and removal. A single bumper 46 is shown but any number of bumpers 46 may be included. The bumper 46 is shown to be a fixed element configured to remain stationary during movement of the safe 12 but it may also be a moveable element, such as being a motorized element configured to facilitate motorized movement of the safe 12 into and out of the sleeve 16, e.g., using a motorized latch configured to pull on a clip included on the safe 12. The bumper 46 may be sized to prevent contact by being configured with a depth slightly greater than a distance by which the fasteners 40 would extend internally into the sleeve 16. The bumper 46 may also be configured to facilitate supporting the safe 12 against lateral movement within the sleeve 16. The upper portion 34 of the front sleeve wall 36 may include a ledge 48 extending rearwardly to support a bottom portion of the safe 12. The ledge 48 may extend approximately an entire length of the sleeve 16. The ledge 48 is not shown to include rollers or other features to facilitate insert in removal of the safe 12 but such features may be included, particularly dependent on the difficulties associated with moving the safe 12 relative to the sleeve 16, i.e., rollers may be desirable in the event the safe 12 is relatively heavy.

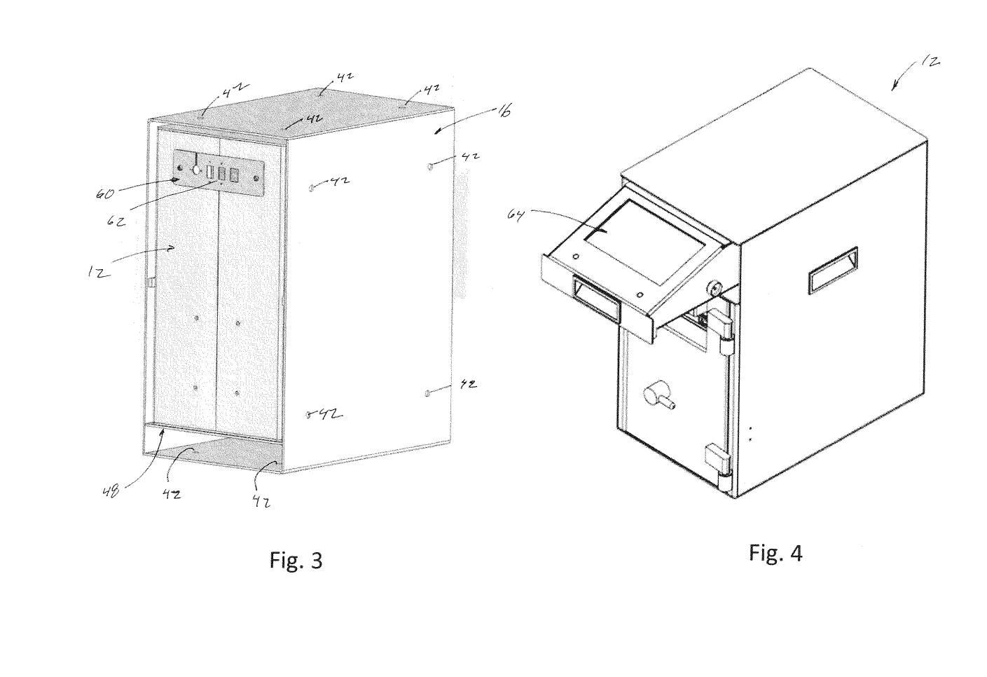

FIG. 3 illustrates a perspective view of the safe and sleeve where the ledge 48 can be seen to support the safe. One or more apertures 42 may be included within a portion of the sleeve 16 below the ledge 48 to facilitate receipt of fasteners (not shown) used to anchor the safe 12 to a floor other structure below the sleeve 16. As shown in FIG. 2, a portion of the ledge 48 may include larger apertures 50 to facilitate access to the fasteners positioned below the ledge 48, i.e., the ledge apertures 50 may be larger than the other apertures 42 to facilitate a tool other device to insert or anchor the fasteners through the bottom of the sleeve 16. The ledge 48 is also shown to include a channel 52 centered proximate the sleeve lock 20. The channel 48 may be included to facilitate ease of manufacturing the sleeve 16. Instead of the channel 52, the ledge 48 may include an opening or other feature (not shown) to facilitate movement of the arm 32. The arm 32 may be configured to rotate about a locking mechanism such that it is positioned above the ledge 48 when in the locked position and below the ledge 48 when in the unlocked position. The safe 12 may include a recess, cavity other feature (not shown) to facilitate receipt of the arm 32. The interaction between the arm 32 and the safe 12 may be sufficient to prevent removal of the safe 12 when properly seated within the sleeve 16 while the sleeve lock 20 is in the locked position.

The safe 12 is shown to include a junction box or other electrical interface 60. The electrical interface 60 may include a plurality of ports 62 to facilitate connecting various wires to electronic components of the safe. As shown in FIG. 4, the safe 12 may include an electronic display 64 to facilitate electronic control of the safe 12. The electronic display 64 may be retracted from the safe 12 to facilitate input of an electronic code used to unlock the lockable safe door 14 and/or to perform other electronic related operations, including programming the safe 12 to receive currency through a bill validator 66. The electrical interface 60 may be configured to facilitate communication between the electronic components of the safe 12 and network elements associated with tracking and monitoring activities of the safe 12. In this manner, currency processing with the bill validator or currency otherwise inserted through the safe 12 may be recorded with the electronic safe components and reported through the electric interface 60 to a monitoring entity. This capability may be beneficial in assessing a capacity of the safe 12 and whether or not a need exists to replace the safe 12 with a new safe 12, such as when the contents of the safe 12 begin to exceed the safe 12 capacity and/or when a particularly valuable element is received within the safe 12 such that it may be desirable to move it quickly.

The safe 12 may include a housing 70 configured to enclose or otherwise secure the electronic touchscreen 64, the bill validator 66, the lockable door 14 and other elements, i.e., the storage cassette, etc. The housing 70 may generally define a front side 72, a left side 74, a right side 76, a top side 78, a bottom side 80, and a rear side 82 of the safe 12. A forward end 86 of the sleeve 16 may be configured to extend slightly past the front side 72 of the housing 70 in order to extend past or at least cover substantially all of a lateral portion of a hinge 90 included on the lockable door 14. The sleeve wall 36 may be correspondingly shaped and sized such that the sleeve 16 covers the lateral side of the hinge 90 to thwart access to an underside of the hinge 90 in order to limit an ability of a jack or other element to be inserted under the hinge 90 to facilitate prying the safe 12 from its anchoring to the floor/cabinet 18. The sleeve 16 is shown to include the opening 26 of approximately the same size and shape as the front side 72 of the safe 12 with a length, height, and width approximating the length, height, and width of the sides of the safe 12. In this manner, the sleeve 16 essentially encloses at least the top 78, bottom 80, left 74, and right sides 76 of the safe 12, or most of an outer perimeter of the safe 12. Depending on particular configurations of the cabinet 18 or other feature to which the sleeve 16 is affixed, the sleeve 16 may be sized and shaped to enclose more or less of the safe 12, e.g., the sleeve 16 may be configured to enclose a 4 half of the top 78, bottom 80, left 74, and right sides 76 of the safe 12.

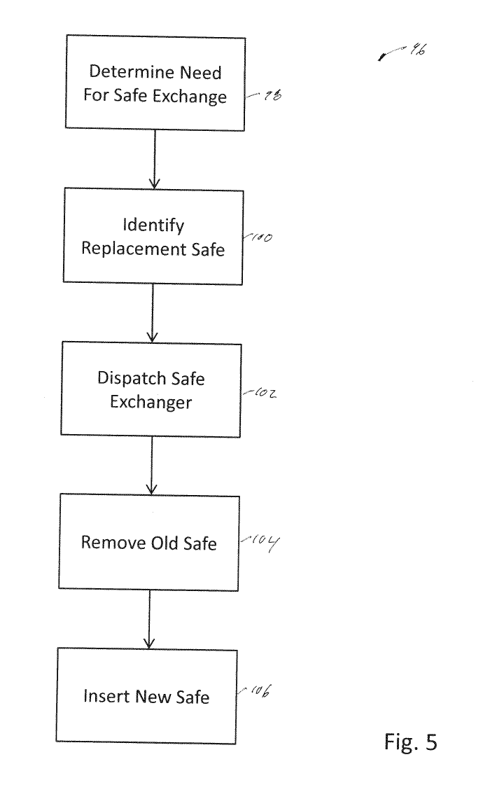

FIG. 5 illustrates a flowchart 96 of a method of facilitating safe exchange in accordance with one non-limiting aspect of the present invention. The method may be embodied in a computer-readable medium having non-transitory instructions stored therein, which when executed with a processor, facilitate one or more aspects of the contemplated safe exchange method. The computer-readable medium may be associated with a server or other entity tasked with monitoring a plurality of safes deployed within various geographical areas where the safes have capabilities to facilitate the contemplated exchange. While the flowchart illustrates a particular number and sequence of operations, the present invention is not necessarily so limited and fully contemplates facilitating safe exchange according to other sequences and processes.

Block 98 relates to determining a need for safe exchange. The need may be determined from signals transmitted from one of a plurality of deployed safes. The safes may be configured to electronically monitor currency or other elements stored within the safe and to generate a particular exchange signal when it becomes desirable to replace the safe. This may occur for various reasons. The safe determined for exchange may be assessed according to various messages to identify its particular configuration, shape and other operating requirements. Block 100 relates to processing these variables in order to identify a suitable replacement safe. Once the suitable replacement safe is determined, Block 102 relates to dispatching a safe exchanger. The safe exchanger may be associated with a secured entity responsible for transporting currency and other valuables between different locations. An electronic message may be transmitted to the safe exchanger with information regarding the safe needed to replace the existing safe and/or other information regarding security or other cautions to be taken when transporting the old safe.

Block 104 relates to removing the old safe determined for safe exchange. This may include transmitting instructions to the safe exchanger regarding particular requirements to unlock the sleeve, i.e., a message may be transmitted to a wireless device associated with the safe exchanger to provide instructions on how to deactivate or otherwise unlock the sleeve from the safe. This may also include providing the safe exchanger with a key or other mechanical device sufficient to facilitate unlocking the sleeve lock. The sleeve lock shown above is a mechanically actuated device but the present invention fully contemplates the sleeve having an electronic combination lock or other lock. In the event the sleeve includes an electronic combination lock, the safe exchanger may be provided with a combination suitable for unlocking the sleeve. Optionally, while the safe is shown to be connected through wires to a network, the sleeve may be similarly connected such that the process of removing the old safe may include transmitting a message to the sleeve instructing the sleeve to unlock the safe.

The removal of the old safe may occur without unlocking the safe, i.e., the lockable safe door behind which the storage cassette maintains the items provided in the safe for safekeeping may remain locked. The process of removing the old safe may include electronic and non-electronic operations. The electronic operations may relate to transmitting a message to the safe instructing the safe to prepare for removal by locking the safe door and/or engaging other security measures designed to prevent access to the safe while being transported, i.e., wiping or deleting the electronic combination currently in use in order to revert to another combination that becomes valid only after successful delivery of the safe to a secure location. Additional electronic operations may occur in the event that the sleeve lock is electronically operable and/or if removal of the safe can be electronically controlled, e.g., in the event a motor is used to insert and remove the safe. The non-electronic operations may include the safe exchanger mechanically actuating the sleeve lock from the locked position to the unlocked position. Block 106 relates to inserting the new safe once the sleeve lock is rotated to the unlocked position and thereafter re-locking the safe.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A validating system comprising:
a safe; a
a sleeve formed of a tamper resistant material, the sleeve shaped to enclose an outer perimeter of the safe, the sleeve including a retaining feature configured to affix the sleeve to a fixed structure other than the safe, the sleeve including a lock operable between a locked position and an unlocked position, the locked position causing the lock to engage the safe to prevent removal from the sleeve, the unlocked positioned causing the lock to disengage the safe to permit removal from the sleeve.

2. The validating system of claim 1 wherein the safe includes an electronic touchscreen configured to facilitate electronic control of the safe, a bill validator configured to process currency for receipt within the safe and a removable cassette configured to store the currency, each of the electronic touchscreen, the bill validator and the removable cassette being enclosed within a housing, the housing including a lockable door through which the cassette is removable, an exterior of the housing defining substantially all of the outer perimeter of the safe enclosed with the sleeve.

3. The validating system of claim 2 wherein the housing is characterized at least in shape as having a top side, a bottom side, a left side, a right side, a front side and a rear side, wherein the sleeve is configured to enclose at least the top, bottom, left and right sides and not an entirety of the front side.

4. The validating system of claim 3 wherein the sleeve includes an opening proximate in size to the front side of the safe, the front side of the safe having the lockable door, the safe being removable through the opening.

5. The validating system of claim 4 wherein the lock is positioned below the opening to engage the bottom side of the safe.

6. The validating system claim 4 wherein the lock includes an arm configured to insert within a cavity on the bottom side of the safe when the lock is in the locked position and configured to be de-inserted from the cavity when the lock is in the unlocked position.

7. The validating system of claim 6 wherein the lock is included within a forward wall of the sleeve, the forward wall being positioned below the opening.

8. The validating system of claim 7 wherein the arm is configured to extend above an upper portion of the wall when the lock is in the locked position and to be positioned below the upper portion of the wall when the lock is in the unlocked position.

9. The validating system of claim 8 wherein a height of the lock is approximately equal to a height of the wall.

10. The validating system of claim 8 wherein the lock is the only lock used to secure the safe within the sleeve such that the safe is immediately removable from the sleeve when the lock is in the unlocked position.

11. The validating system of claim 8 wherein the sleeve includes a ledge proximate the upper portion of the wall, the ledge extending approximately an entire length of the sleeve to support the bottom side of the safe.

12. The validating system of claim 11 wherein at least a portion of the retaining feature is located below the ledge.

13. The validating system of claim 1 wherein the retaining feature includes a plurality of apertures, each aperture being configured to receive a fastener configured to secure the sleeve to the fixed structure.

14. The validating system of claim 13 wherein the sleeve includes a plurality of fixed bumpers configured to offset the safe from the apertures by an amount sufficient to prevent the safe from contacting the fasteners, the fixed bumpers remaining stationary while the safe is being removed from the sleeve.

15. The validating system of claim 1 wherein the housing includes a hinge configured to facilitate opening and closing the lockable door, wherein the sleeve extends beyond the hinge to limit access to an underside of the hinge.

16. A validating system comprising:
an electronically operable safe, the safe being a standalone unit configured to electronically process paper currency received through an automated validator; and
a retainer configured to lockably retain the safe to a fixed structure without requiring the safe to be directly secured to the fixed structure, the retainer including a lock operable to a first position to prevent removal of the safe and to a second position to allow removal of the safe.

17. The validating system of claim 16 wherein the fixed structure is a cabinet.

18. The validating system claim 17 further comprising:
a plurality of fasteners configured to retain the sleeve to the cabinet, the fasteners being removable without use of a key whereas the lock requires use of a key, a combination, an electronic input or other secure implement to actuate from the first position to the second position; and
a plurality of fixed bumpers configured to offset the safe from the apertures by an amount sufficient to prevent the safe from contacting the fasteners, the fixed bumpers remaining stationary while the safe is being removed from the sleeve.

19. The validating system of claim 16 wherein:
the safe is characterized at least in shape as having a top side, a bottom side, a left side, a right side, a front side and a rear side;
the retainer is configured to enclose at least the top, bottom, left and right sides and not an entirety of the front side;
the retainer includes an opening proximate in size to the front side of the safe;
the front side of the safe has the lockable door;
the safe is removable through the opening;
the lock is positioned below the opening to engage the bottom side of the safe;
the lock includes an arm configured to insert within a cavity on the bottom side of the safe when the lock is in the first position and configured to be de-inserted from the cavity when the lock is in the second position;
the lock is included within a forward wall of the sleeve;
the forward wall is positioned below the opening;
the arm is configured to extend above an upper portion of the wall when the lock is in the first position and to be positioned below the upper portion of the wall when the lock is in the second position; and
the lock is the only lock used to secure the safe within the sleeve such that the safe is removable from the sleeve when the lock is in the second position.

20. A method of facilitating validation of paper currency comprising:
removing a first safe configured to electronically validate paper currency from a sleeve, the sleeve being affixed to a relatively immovable structure, the sleeve including a lock operable between an unlocked positioned and a locked position, the locked position preventing removal of the first safe from the sleeve and the unlocked position allowing the removal, including actuating the lock from the locked position to the unlocked position; and
securing a second safe configured to electronically validate paper currency within the sleeve, including actuating the lock from the unlocked position to the locked position, the locked position preventing removal of the second safe from the sleeve.
